(19) United States
(12) Patent Application Publication
(10) Pub. No.: US 2017/0053289 A1
(43) Pub. Date: Feb. 23, 2017

(54) ISSUE TRACKING AND RESOLUTION SYSTEM

(71) Applicant: BEET, LLC, Plymouth, MI (US)

(72) Inventor: David Jingqiu Wang, Northville, MI (US)

(73) Assignee: BEET, LLC, Plymouth, MI (US)

(21) Appl. No.: 15/306,953

(22) PCT Filed: May 8, 2015
(86) PCT No.: PCT/US2015/030039

§ 371 Date: Oct. 26, 2016

Related U.S. Application Data
(63) Continuation-in-part of application No. 14/705,421, filed on May 6, 2015.
(60) Provisional application No. 61/990,151, filed on May 8, 2014.
(60) Provisional application No. 61/990,156, filed on May 8, 2014.
(60) Provisional application No. 61/990,158, filed on May 8, 2014.
(60) Provisional application No. 61/990,159, filed on May 8, 2014.
(60) Provisional application No. 61/990,163, filed on May 8, 2014.
(60) Provisional application No. 61/990,169, filed on May 8, 2014.
(60) Provisional application No. 61/990,170, filed on May 8, 2014.
(60) Provisional application No. 61/990,172, filed on May 8, 2014.
(60) Provisional application No. 61/990,148, filed on May 8, 2014.
(60) Provisional application No. 62/060,501, filed on Oct. 6, 2014.

(51) Int. Cl. G06Q 30/00; G06Q 10/06; G06Q 10/10; G05B 23/02

(52) U.S. Cl. CPC G06Q 30/016; G05B 23/0278; G06Q 10/063114; G06Q 10/103; G05B 2219/31365

(57) ABSTRACT

An issue tracking and resolution method includes receiving an issue to an issue tracking and resolution (ITR) system via a network. The ITR system includes a directory including a plurality of directory items. The method further includes associating the issue with a first directory item of the plurality of directory items, where the plurality of directory items includes at least one machine and at least one operation performed by the machine. The method includes subscribing a first subscriber to the ITR system via the network; and associating the first subscriber with at least one directory items of the plurality of directory items. The first directory item is compared with at least one directory item associated with the first subscriber using the ITR system, and an issue notification is sent to the first subscriber when the first directory item matches the directory item associated with the first subscriber.

### CROSS-REFERENCE TO RELATED APPLICATIONS

This Application claims the benefit of PCT Application PCT/US2015/030039 filed May 8, 2015, U.S. application Ser. No. 14/705,421 filed May 6, 2015, U.S. Provisional Application 61/990,148 filed May 8, 2014, U.S. Provisional Application 61/990,151 filed May 8, 2014, U.S. Provisional Application 61/990,156 filed May 8, 2014, U.S. Provisional Application 61/990,158 filed May 8, 2014, U.S. Provisional Application 61/990,159 filed May 8, 2014, U.S. Provisional Application 61/990,163 filed May 8, 2014, U.S. Provisional Application 61/990,169 filed May 8, 2014, U.S. Provisional Application 61/990,170 filed May 8, 2014, U.S. Provisional Application 61/990,172 filed May 8, 2014, and U.S. Provisional Application 62/060,501 filed Oct. 6, 2014, which are each hereby incorporated by reference in their entirety.

### TECHNICAL FIELD

The present disclosure relates generally to operating and managing automated equipment, including collecting and capturing automation data using an automation controller in communication with a computing device.

### BACKGROUND

A facility may include multiple machines. Each machine can be controlled by a programmable logic controller (PLC) or similar controller connected to multiple machine elements, power sources and sensors of the machine. The controller in communication with the sensors receives sensor inputs to the controller indicating condition states of the various elements. The controller may be programmed to scan at a predetermined frequency through a scan cycle, defined for example, by a sequence of operations (SOP) to be performed by the elements of the machine, and, based on the sensor inputs and condition states received by the controller, selectively energize the power sources to actuate the elements to perform operations defined by the program. Each machine and its associated controller may be operated independently from each other machine. When the inputs provided by each controller of the independent machines are not consolidated for analysis, opportunities to increase facility efficiency and decrease facility downtime can be missed.

### SUMMARY

An automated operating system (AOS) is provided which is advantaged by accumulating data and inputs from various elements, machines, and facilities of an enterprise operating the AOS, and/or over various operating time periods, and analyzing the accumulated data and inputs using a server to identify issues, trends, patterns, etc. which may not be identifiable by independent machine controllers of the machines in the enterprise, for example, where such issues may result from interactions of multiple inputs which are outside the scope of inputs controlled by or analyzed by any individual one of the machine controllers, and/or which may be identifiable only by a combination of inputs from multiple machine, multiple time periods such as operating shifts, and/or by a combination of inputs to determine cumulative issues within a production line, a zone, a group of common elements or common machines, etc., and using the AOS to identify, action responses to, manage and/or prevent issues using the collective resources of the enterprise.

The AOS described herein is advantaged by the capability to generate a plurality of differently configured data displays generated from a plurality of corresponding display templates populated with real time data which can be displayed to a user in real time, on a user interface of a user device, to allow real time monitoring of the operation, machine, etc. defining the data display being viewed by the user. Differentiation of certain data features of the data display provides immediate visual recognition by the user/viewer of a condition state and/or alert status of a differentiated data feature which requires investigation and/or resolution. The differentiated data feature may be visually differentiated, for example, by color, pattern, font, lighting, etc. for efficient viewing.

Early recognition by the user/viewer of a condition state and/or alert status supports early and/or acceleration recognition of an issue for issue investigation, resolution and/or corrective action. Once an issue has been identified, issue investigation is initiated and proceeds through a resolution phase. Expediting issue resolution is essential to minimizing losses associated with the ongoing occurrence of the issue, hence an issue tracking and resolution system which expedites the issue investigation and resolution process is advantaged by decreasing the time an issue continues to occur and/or remains unresolved. An issue tracking and resolution system is provided which is advantaged by expediting the formation of an issue investigation team of persons knowledgeable in the issue subject matter, and by providing a tracking mechanism for real time reporting and tracking of investigative actions and corrective actions and countermeasures in a network communications enabled system.

An issue tracking and resolution method is provided, which includes receiving an issue to an issue tracking and resolution (ITR) system via a network in communication with the ITR system. The ITR system includes a directory including a plurality of directory items. The method further includes associating the issue with a first directory item of the plurality of directory items, where the plurality of directory items includes at least one machine and at least one operation performed by the machine. The method includes subscribing a first subscriber to the ITR system via the network; and associating the first subscriber with at least one directory items of the plurality of directory items. The first directory item is compared with the at least one directory item associated with the first subscriber using the ITR system, and an issue notification is sent to the first subscriber when the first directory item matches the at least one directory item associated with the first subscriber. The issue notification is received by the first subscriber via the network, and the first subscriber dispositions the issue notification via the network, by performing one of returning the issue notification to an issue originator, transferring the issue notification to a second subscriber of the ITR system, and accepting the issue notification. The ITR system includes an issue resolution log for posting log entry to the issue resolution log reporting the disposition performed by the first subscriber and issue resolution activities.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic view of an example of an automation operating and management system including first, second, third and fourth level controllers;

FIG. 2 is a schematic view of an example of a machine including a first level controller and a second level controller;

FIG. 3 is a schematic illustration of an example of a method for tracking and resolving issues related to the system of FIG. 1;

FIG. 4 is a schematic illustration of an example of a user device of FIG. 1;

FIG. 5 is a schematic illustration of an example of a display of an object tree of the system of FIG. 1 on the user device of FIG. 4;

FIG. 6 is a schematic illustration of the display of the object tree of FIG. 5;

FIG. 7 is a schematic illustration of an example of a user interface of an issue tracking and resolution system;

FIG. 8 is a schematic illustration of an example of user interface of an issue log of the issue resolution system;

FIG. 9 is a schematic illustration of an example of a machine heartbeat of a group of elements of the machine of FIG. 2; and

FIG. 10 is a schematic illustration of an example of a machine control interface showing stoppage times for zones of machines of the system of FIG. 1.

### DETAILED DESCRIPTION

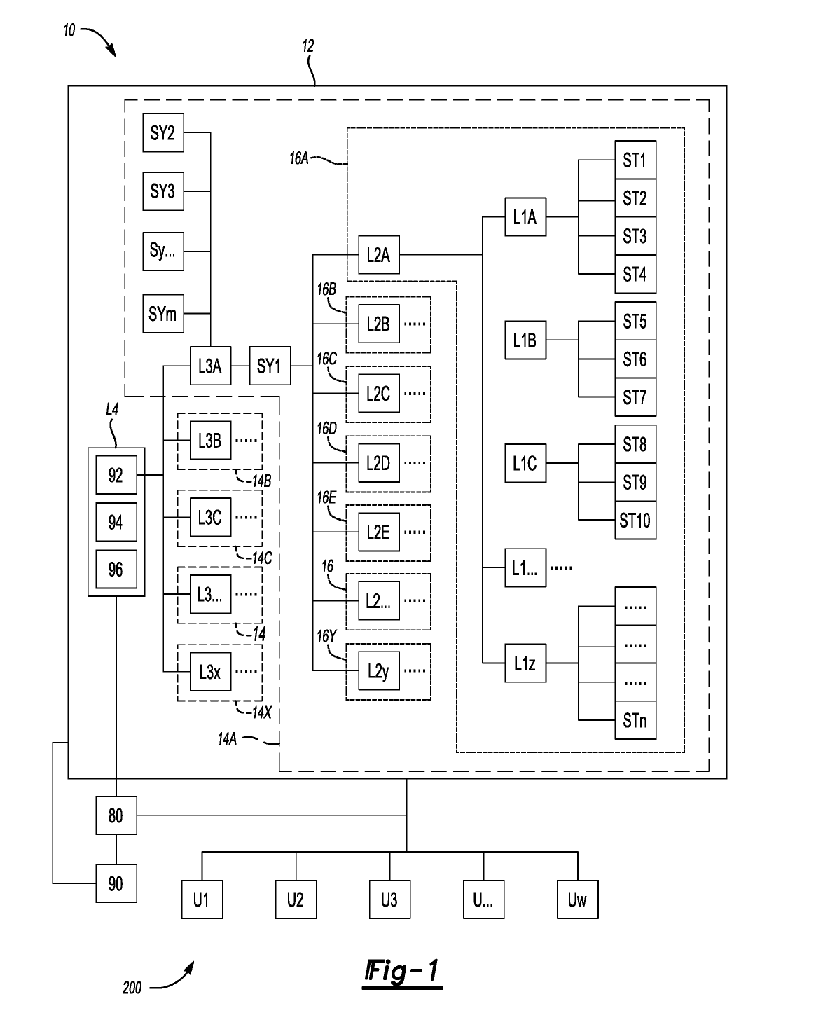

Referring to the drawings wherein like reference numbers represent like components throughout the several figures, the elements shown in FIGS. 1-13 are not to scale or proportion. Accordingly, the particular dimensions and applications provided in the drawings presented herein are not to be considered limiting. FIG. 1 shows an automation operating and management system 10 for controlling systems, machines, and elements operating within an enterprise 12. The automation operating and management system 10 may be referred to herein as an automation operating system (AOS). The enterprise 12 includes an enterprise server L4, which may also be referred to herein as a fourth layer server, for receiving and consolidating data from multiple facilities 14 (shown in the example of FIG. 1 as facilities 14A . . . 14x and referred to herein collectively as facilities 14) within the enterprise 12. Each of the facilities 14 includes a facility server L3, which may also be referred to herein as a third layer server, for receiving and consolidating data from multiple facility systems SY (shown in the example of FIG. 1 as systems SY1 . . . SYm and referred to herein collectively as systems SY) within each of the facilities 14. Each facility server L3 is in communication with the enterprise server L4. At least one of the facility systems SY in each of the facilities 14 (shown in the example of facility 14A as system SY1) includes multiple machines 16 (shown in the example of FIG. 1 as machines 16A . . . 16y and referred to herein collectively as machines 16). The machines 16 can be any machines that perform coordinated operations including automated machines. In an illustrative and non-limiting example described herein the machines 16 can be machines such as automated machines performing operations in a manufacturing plant and/or an assembly facility. The enterprise server L4 can be embodied as one or more computer devices having a processor 94 and a memory 92, some of which is computer-readable tangible, non-transitory memory arranged on a printed circuit board or otherwise available to the processor 94. Instructions embodying the methods described herein may be programmed into memory 92 and executed as needed via the processor 94 to provide functionality of the AOS 10 as described herein. The memory 92 may include, by way of example, sufficient read only memory (ROM), optical memory, flash or other solid state memory, and the like. Transitory memory such as random access memory (RAM) and electrically-erasable programmable read-only memory (EEPROM) may also be included, along with other required circuitry (not shown), including but not limited to a high-speed clock, current/voltage/temperature/speed/position sensing circuitry, analog-to-digital (A/D) circuitry, digital-to-analog (D/A) circuitry, a digital signal processor, and any necessary input/output (I/O) devices and other signal conditioning and/or buffer circuitry. The enterprise server L4 can include a communications interface 96 for communication with other controllers and/or servers in the enterprise 12, including for example, for communication with each of a third layer server L3, a second layer controller L2 and a first layer controller L1 of the enterprise 12. The fourth layer (enterprise) server L4, third layer servers L3, second layer controllers L2 and first layer controllers L1 can be in communication with each other via a network 80, which may be a wired or wireless network.

AOS 10 can include a data storage memory 90 which can be used to store data received from one or more of the fourth layer server L4, third layer servers L3, second layer controllers L2 and first layer controllers L1. By way of example, the data storage memory 90 may be accessed via the network 80 and/or may be external to the enterprise 12, for external data storage. The data storage memory 90 can be accessible via the enterprise server L4 and/or via the network 80. The data storage memory 90 can include, by way of example, sufficient read only memory (ROM), optical memory, flash or other solid state memory, and the like to store data received from the enterprise 12. Transitory memory such as random access memory (RAM) and electrically-erasable programmable read-only memory (EEPROM) may also be included, along with other required circuitry (not shown), including but not limited to a high-speed clock, analog-to-digital (A/D) circuitry, digital-to-analog (D/A) circuitry, a digital signal processor, and any necessary input/output (I/O) devices and other signal conditioning and/or buffer circuitry.

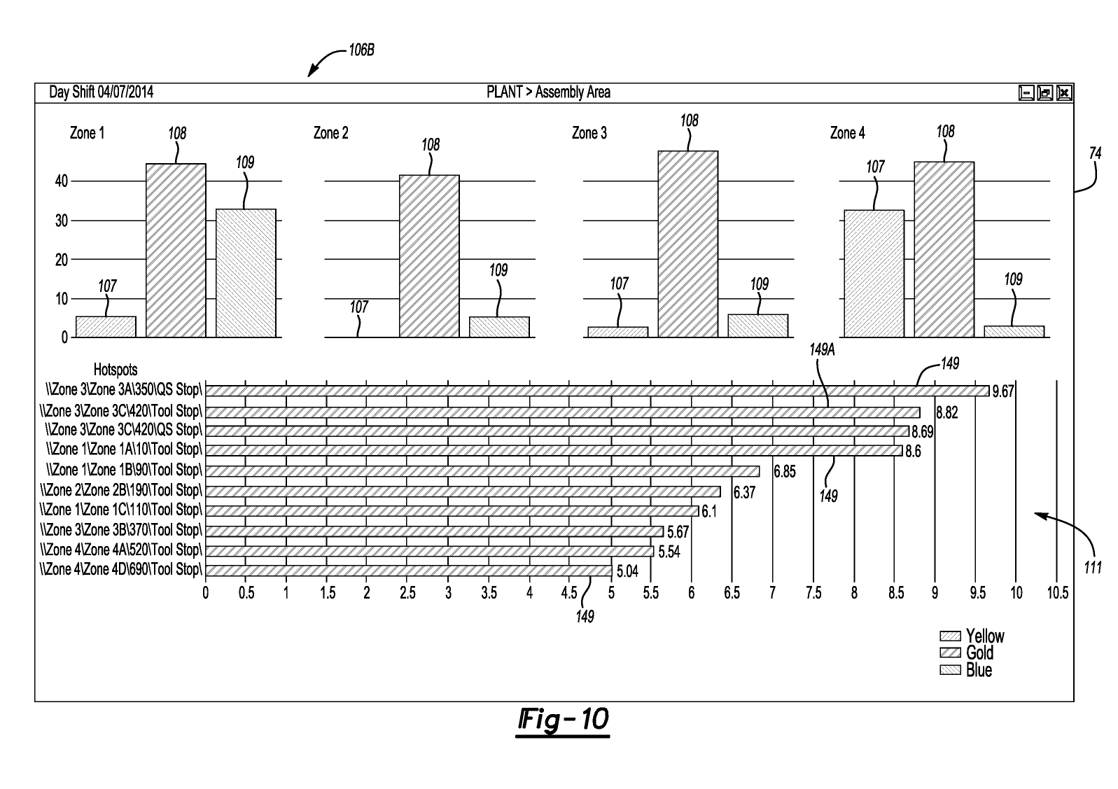

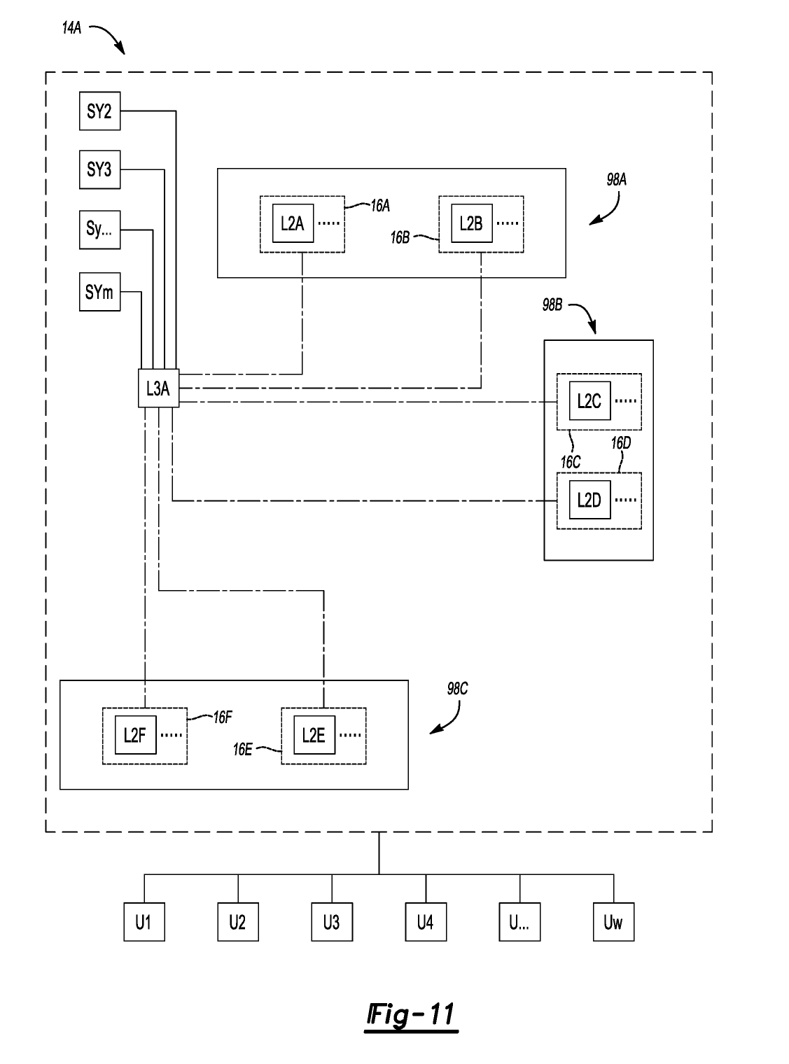

AOS 10 can further include one or more user devices (shown in the example of FIG. 1 as user devices U1 . . . Uw and referred to herein collectively as user devices U) in communication with the enterprise 12 and with data collected by AOS 10, via a wired connection or a wireless connection, for example, via the network 80. By way of non-limiting example, a user device U can be a computing device such as a personal computer, tablet, laptop, smart phone, personal digital assistant, or other personal computing device for viewing information including data related to and/or provided by the enterprise 12. In one example, the user device U can be a portable computing device such as a personal computer, notebook, tablet, smart phone, personal data assistant, etc., including, as shown in FIG. 4, a processor 76 and memory 78, some of which is computer-readable tangible, non-transitory memory arranged on a printed circuit board or otherwise available to the processor 76. The memory 78 may include, by way of example, sufficient read only memory (ROM), optical memory, flash or other solid state memory, and the like. Transitory memory such as random access memory (RAM) and electrically-erasable programmable read-only memory (EEPROM) may also be included, along with other required circuitry (not shown), including but not limited to a high-speed clock, location sensing circuitry, analog-to-digital (A/D) circuitry, digital-to-analog (D/A) circuitry, a digital signal processor, and any necessary input/output (I/O) devices and other signal conditioning and/or buffer circuitry. The user device U can include a connector port 72 for connecting the user device to another device (not shown) and/or for connection to the network 80 via a wired connection. The user device U includes a communications interface which can be a wireless or wired interface, for connection of the user device U to the network 80 for communication with one or more of the controllers L1, L2, the servers L3, L4, another of the user devices U, and/or the data storage memory 90. The user device U includes a graphical user interface 74, which in a preferred example is a graphical touch screen, such that a user can provide input to the user device 74, including commands, via the touch screen 74 and/or standard tool bars 82. In one example, the user may monitor the data collected from one or more of the elements E and/or machines 16 in the enterprise 12, which may be displayed on the user device U as a machine control interface 84 (see FIGS. 10 and 11), where the machine control interface 84 can be defined by one of the machine controller L2, the facility server L3 and/or the enterprise server L4. In one example, the user device U can display a machine control interface for one or more of the machines 16 and can use the user interface 74, in one example, as a touch screen for interacting with the information and data of the enterprise 12 and/or for controlling the machine 16 via the machine control interface 84. In one example, the user may subscribe to an issue tracking and resolution system to receive alerts for one or more elements E and/or machines 16 being monitored by the user, where the alerts may be received by the user on the user device U as one or more of a text message, instant message, e-mail, or other alert indicator.

In the example shown, each of the machines 16 includes a second layer controller L2 and one or more first layer controllers L1. Each of the machine controllers L2 (shown in the example of FIG. 1 as machine controllers L2A . . . L2y and referred to herein collectively as machine controllers L2) within a respective facility 14 are in communication with the respective facility controller L3 for that facility 14. A second layer controller L2 may also be referred to herein as a machine controller. Each machine controller L2 of a respective machine 16 is in communication with the first layer controllers L1 of that respective machine. A first layer controller L1 may be referred to herein as a base layer controller. The machine controllers L2 and the base layer controllers L1 can each perform specific functions in controlling and monitoring the operation of the machine 16. Each machine controller L2 and each base layer controller L1 can be embodied as one or more computer devices having a processor and memory, some of which is computer-readable tangible, non-transitory memory arranged on a printed circuit board or otherwise available to the processor. Instructions may be programmed into the memory of each of the machine controllers L2 and each of the base layer controllers L1 and executed as needed via the processor of the respective controller L2, L1 to provide the control functionality over the machines 16 and/or elements E within the control of each respective machine controller L2 and/or each respective base layer controller L1. The memory of each machine controller L2 and each base layer controller L1 can include, by way of example, sufficient read only memory (ROM), optical memory, flash or other solid state memory, and the like. Transitory memory such as random access memory (RAM) and electrically-erasable programmable read-only memory (EEPROM) may also be included, along with other required circuitry (not shown), including but not limited to a high-speed clock, current/voltage/temperature/speed/position sensing circuitry, analog-to-digital (A/D) circuitry, digital-to-analog (D/A) circuitry, a digital signal processor, and any necessary input/output (I/O) devices and other signal conditioning and/or buffer circuitry. Each machine controller L2 and each base layer controller L1 can include one or more monitoring, measuring and/or control devices for monitoring, measuring and/or controlling the machines 16 and/or elements E within the control of each respective machine controller L2 and/or each respective base layer controller L1.

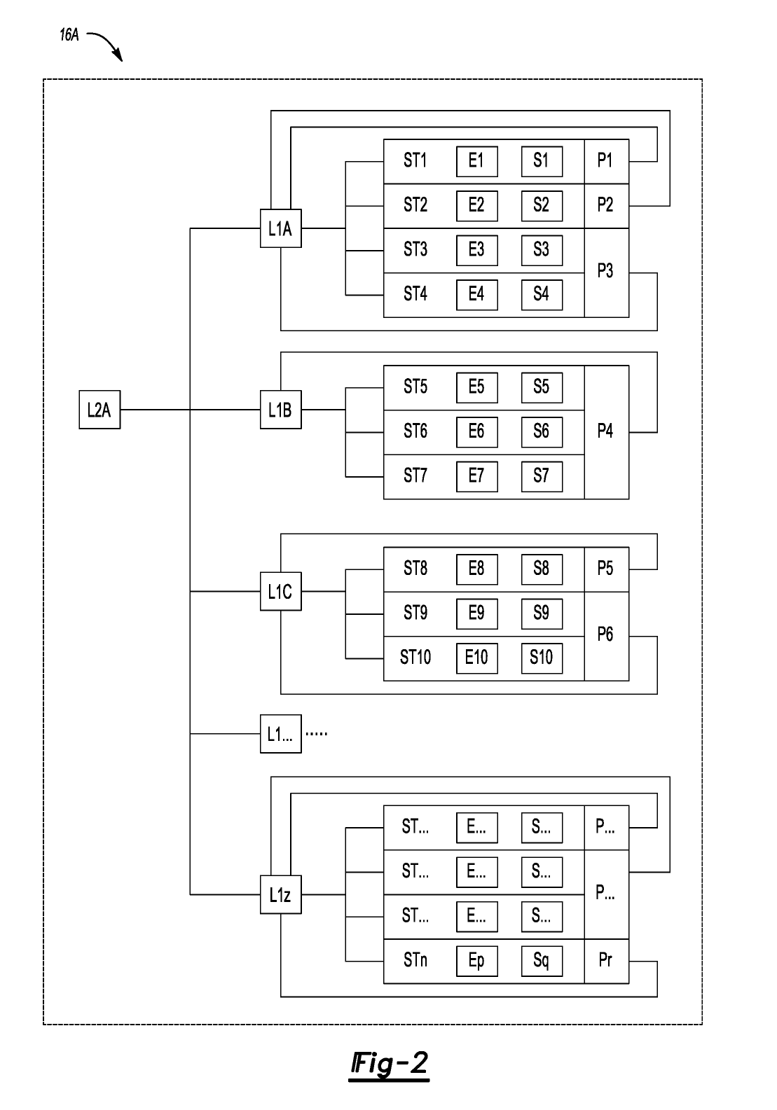

Each machine 16 includes a plurality of stations ST (shown in the example of FIGS. 1 and 2 as stations ST1 . . . STn and referred to herein collectively as stations ST) for performing an operational cycle of the machine 16, where the operational cycle includes operations of the machine 16 performed in a predetermined sequence controlled by the base layer controller L1 and/or the machine controller L2 of the machine 16. The predetermined sequence in which the operations in the operational cycle is performed can be defined by a sequence of operations 39 and/or a portion of a sequence of operations 39 defined for that machine 16 by the machine controller L2 of the machine 16. It would be understood that the machine 16 would, in operation, repeatedly perform the operational cycle comprising the sequence of operations 39 under control of the machine controller L2 and/or the base layer controller L1.

Each of the base layer controllers L1 (shown in the example of FIGS. 1 and 2 as base layer controllers L1A . . . L1z and referred to herein collectively as the base layer controllers L1) controls operations performed by at least one of the stations ST in communication with the respective base layer controller L1. As shown in FIG. 2, each station ST includes one or more elements E (shown in the example of FIG. 2 as elements E1 . . . Ep and referred to herein collectively as elements E), for performing various operations and/or tasks of the respective station ST. Using an illustrative example of a manufacturing and/or assembly enterprise 12, examples of elements E used to perform the various operations of a manufacturing and/or assembly operation performed by a machine 116 and/or station ST can include clamps, cylinders, collets, pins, slides, pallets, etc., where the examples provided herein are non-limiting.

Each station ST further includes one or more power sources P (shown in the example of FIG. 2 as power sources P1 . . . Pr and referred to herein collectively as power sources P), for providing power to one or more elements E and for selectively energizing a respective element E in response to a signal from the base layer controller L1. Each station ST further includes one or more sensors S (shown in the example of FIG. 2 as sensors S1 . . . Sq and referred to herein collectively as sensors S), for sensing a state of at least one of the elements E and the power source P of the station ST and providing an input to the base layer controller L1 indicating the state sensed by the sensor S.

A state, which may be referred to as a condition state or as a condition, as used herein, refers to a state of the object, a condition, a status, a position, or other property being monitored, measured and/or sensed. Non-limiting examples of condition states including cycle start time, cycle stop time, element start time, element travel, element stop time, position of an element or object, a dimensional measurement of an object which can include a dimensional measurement of a feature of an element E, a feature of a machine 16, a feature of a workpiece (not shown) to which an operation is being performed by a machine 16 or an element E, a condition of one or more of an element E, machine 16 or workpiece, or a condition of the environment within the facility 14. A condition state could further include for example, operating conditions such as on, off, open, closed, auto, manual, stalled, blocked, starved, traveling, stopped, faulted, OK, good, bad, in tolerance, out of tolerance, present, not present, extended, retracted, high, low, etc., and can include for example, a measure of a physical property such as chemistry, temperature, color, shape, position, dimensional conditions such as size, surface finish, thread form, functional parameters such as voltage, current, torque, pressure, force, etc., such that it would be understood that the terms state, condition and/or condition state as describing inputs to the AOS 10 are intended to be defined broadly. By way of non-limiting example, a sensor S may be configured as a limit switch, a proximity switch, a photo eye, a temperature sensor, a pressure sensor, a flow switch, or any other type of sensor which may be configured to determine if one or more states are met during operation of the automated system 10, and to provide an output to the at least one automation controller, such as the base layer controller L1 and/or the machine layer controller L2, which is received by the controller L1, L2 as an input corresponding to the state determined by the sensor S. The sensor S output may be configured, for example, as a signal provided to the base layer controller L1 and/or to the machine layer controller L2, and received by the base layer controller L1 and/or to the machine layer controller L2 as an input including input data. The sensor S may be configured to provide a discrete or bit-form output. The sensor S may be configured as an analog sensor and may provide an analog output signal corresponding to one or more of multiple states of a element E or a group of elements E associated with the sensor S, or one or more of multiple states of an environment of the machine 116 and/or the environment of the facility 14 including the machine 16.

The predetermined sequence of operations in the operational cycle can be defined by a sequence of operations 39 and/or a portion of a sequence of operations 39 defined for that machine 16 by the machine controller L2 of the machine 16. In one example, the machine controller L2 can perform the functions of the machine controller L2 and the base layer controllers L1, such that the machine 16 can be configured without the base layer controllers L1. In this example, the machine 16 would, in operation, repeatedly perform the operational cycle comprising the sequence of operations 39 under the independent control of the machine controller L2.

In another example, the controller functions may be divided between the base layer controllers L1 and the machine controller L2, with the base layer controllers L1 functioning as low level controllers and the machine controllers L2 functioning as a high level controller coordinating the operation of the base layer controllers L1 within the machine 16. In this example, the machine 16 would, in operation, repeatedly perform the operational cycle comprising the sequence of operations 39 under the control of the machine controller L2 and the base layer controllers L1, where the machine controller L2 acts as a data collector collecting the condition state data for each of the elements E of the machine 16 from each of the respective base layer controllers L1, and acts as a local area controller to coordinate and control the interaction of the base layer controllers L1 with each other. In this example, each base layer controller L1 within the machine 16 is in communication with each other base layer controller L1 within the machine 16 and with the machine controller L2 to communicate condition states of each of the elements E controlled by that respective base layer controller L1, such that each base layer controller L1 can execute control actions of the respective elements E under the control of the respective base layer controller L1 in response to the condition state data received from the other base layer controllers L1 in the machine 16.

For illustrative purposes and by way of non-limiting example, the enterprise 12 shown in FIGS. 1 and 2 may be a production enterprise including a plurality of manufacturing and/or assembly facilities 14, such as facilities 14A, 14B and 14C. In one example, the facilities 14A, 14B and 14C may be co-located within the production enterprise 12, for example, each of the facilities 14A, 14B and 14C may be sub-factories or assembly lines co-located in a larger building defining the production enterprise 12. In another example, each of the facilities 14A, 14B and 14C may be a stand-alone factory which may be geographically separated from each other and in communication with each other and the enterprise server 12, for example, via the network 80. Facility 14A, for illustrative purposes, is shown in additional detail in FIGS. 1 and 2, and includes a facility server L3A which is in communication with multiple systems SY such as systems SY1, SY2 and SY3 operating in the facility 14A. In the example shown, system SY1 includes manufacturing and/or assembly operations consisting of multiple machines 16 such as machines 16A, 16B, 16C, 16D and 16E.

In the illustrative example, machine 16A is shown in additional detail in FIG. 2, consisting of multiple stations ST such as stations ST1 through ST10. Machine 16A includes a machine controller L2A in communication with multiple base layer controllers L1 such as base layer controllers L1A, L1B and L1C. Each of the base layer controllers L1A, L1B and L1C acts to control multiple stations ST according to instructions received from the machine controller L2A, to perform operations, for example, defined by a sequence of operations 39 stored in the machine controller L2A. For example, as shown in FIG. 2, base layer controller L1A can control the operations of stations ST1, ST2, ST3, ST4 by selectively activating the power sources P1, P2 and P3 to selectively actuate elements E1, E2, E3 and E4. The base layer controller L1A receives sensor outputs from the sensors S1, S2, S3 and S4 which indicate condition states, for example, of the elements E1, E2, E3 and E4. The base layer controller L1A is in communication with base layer controllers L1B and L1C in the present example, and receives condition state input from base layer controllers L1B and L1C indicating the condition states of elements E5 through E10. The base layer controller L1A selectively actuates the elements E1, E2, E3 and E4 according to instructions stored in the memory of the base layer controller L1A, inputs and instructions received from the machine controller L2A and in response to the condition states of the elements E1 through E10, in the present example, received by the base layer controller L1A. The examples described herein and shown in FIGS. 1 and 2 related to machine 16A are illustrative and non-limiting. For example, each of the machines 16 controlled and/or managed by AOS 10 could include a machine controller L2, however could differ in including a base layer controller L1 and/or the number of base layer controllers L1 included in the machine 16, and could differ in the number, arrangement, function, etc. of the stations ST, elements E, sensors S and power sources P from the illustrative example of machine 16A shown in FIGS. 1 and 2.

In the present illustrative example, facility systems SY2 and SY3 shown in FIGS. 1 and 2 can operate in the facility 14A and can be operated and/or managed using the AOS 10 in a manner and/or to provide outputs which can affect the operations of system SY1 in facility 14A, including affecting the efficiency and/or downtime of the machines 16 included in the system SY1. Each of the systems SY2, SY3 includes one or more servers (not shown, referred to herein as a SY server) which can be embodied as one or more computer devices having a processor and memory, some of which is computer-readable tangible, non-transitory memory arranged on a printed circuit board or otherwise available to the processor. Instructions may be programmed into the memory of each SY server and executed as needed via the processor of the SY server to provide monitoring and/or control functionality over the facility operations within the control of the respective SY system. The memory of the SY server can include, by way of example, sufficient read only memory (ROM), optical memory, flash or other solid state memory, and the like. Transitory memory such as random access memory (RAM) and electrically-erasable programmable read-only memory (EEPROM) may also be included, along with other required circuitry (not shown), including but not limited to a high-speed clock, current/voltage/temperature/speed/position sensing circuitry, analog-to-digital (A/D) circuitry, digital-to-analog (D/A) circuitry, a digital signal processor, and any necessary input/output (I/O) devices and other signal conditioning and/or buffer circuitry. Each of the systems SY2, SY3 can include one or more monitoring, measuring and/or control devices and/or sensors for monitoring, measuring and or sensing a state of the facility operations within the control of the respective SY system.

In the present illustrative example of a production enterprise 12, system SY2 can be a facility management system, which may be referred to herein as a facility infrastructure system SY2, for monitoring, measuring and/or controlling various factors of the infrastructure and operating environment of facility 14A, such as electrical power supply provided to the various power sources P, water supply provided to hydraulic and/or coolant systems within the facility 14A and/or coolant systems related to the machines 16, compressed air supply provided within the facility 14A, for example, to pneumatic systems of the machines 16, to pneumatically operated elements E, and/or to pneumatically controlled manual tools such as pneumatic torch wrenches which may be used in manufacturing and/or assembly operations within the facility 14A. It would be understood that variability in each of the electrical power supply, water supply, and compressed air supply could affect the operation, efficiency and downtime of one or more of the machines 16 and/or elements E. For example, a decrease in the pressure of the compressed air supply provided to a pneumatically controlled element E such as a cylinder may decrease the speed at which the cylinder element E travels, increasing the cycle time required for the cylinder element E to travel when performing an operation of a machine 16. For example, an increase in temperature of cooling water circulating in a cooling water jacket of a machine 16 such as a welding machine, may change the efficiency of heat transfer from a work area of the machine 16, affecting the tool life of the welding elements E in the machine 16 and/or the cooling rate of the welds being formed in a product welded by the machine 16. For example, variability in the voltage level of the incoming power supply provided to a power source P can affect the response time of a clamp element E activated by the power source P, thereby affecting the cycle time of the operation performed by the clamp element E. By way of example, system SY2 can monitor, measure, and/or control ambient conditions within the facility 14A, or within a portion of the facility 14A, such as temperature, humidity, etc. For example, the facility 14A may be portioned into multiple zones 98 such as zones 98A, 98B, 98C shown in FIG. 11, where at least one of the machines 16 is located in each zone. By way of example, one of the zones 98A, 98B, 98C can include machines 16 which are performing operations sensitive to ambient temperature and/or humidity conditions, such as an electronics fabrication operation or a painting operation, such that variability in the ambient temperature and/or humidity in that zone may affect the quality of the product produced by the machines 16 in that area. These examples are non-limiting and for illustrative purposes, and it would be understood that variability within facility controlled systems and conditions such as power supply, water supply, compressed air supply, temperature, humidity, etc. can affect the operation of the machines 16, elements E and/or can affect the quality and/or condition of the products produced by and/or the services provided by the machines 16 in multiple ways too numerous to include herein. System SY2 can transmit signals (inputs) to the facility server L3A indicating condition states of the various factors of the operating environment of facility 14A being monitored, measured, and/or controlled by the facility server L3A.

In the present illustrative example of a production enterprise 12, system SY3 can include production control and product assurance operations and can monitor, measure and/or control various factors of the production control and product assurance operations which impact the operation of manufacturing and production system SY1 of facility 14A. For example, the production control operations of system SY3 can monitor inventory levels (on order, in transit, in stock) of machine parts for the machines 16, which may include replaceable service parts (motors, etc.) sensors S (limit switches, etc.) and/or elements E which can include durable (reusable) elements such as clamps, cylinders, etc. and/or consumable (replaceable) elements E such as drills, taps, clamp pads, etc. required for a station ST to complete an operation and/or for the machine 16 to operate. In another illustrative example, the production control operations of system SY3 can monitor inventory levels (on order, in transit, in stock) of vendor supplied (purchased) components and/or material which are provided to the machines 16, for example, as raw material or work pieces on which operations are performed by the machines 16, or are provided to the machines 16, for example, as components to be assembled with other components to form a finished assembly. The product assurance operation, for example, can monitor the condition of vendor supplier (purchased) components and/or materials and indicate the acceptance or rejection of the vendor supplied materials, which could affect the availability of that inventory to the machines 16. In another illustrative example, the product assurance operation can measure and output a condition state of a component or raw material to the facility server L3 and/or to a machine controller L2 of a machine 16 processing the component or raw material, such that the machine 16 in response can adjust settings based on the measured condition state of the incoming component or raw material. For example, a machine 16 may be an oven to temper components made from raw material. The machine 16 via the facility controller L3 can receive hardness data for the raw material from the product assurance system SY3 and adjust the tempering temperature of the oven based on the hardness of the raw material. These examples are non-limiting and for illustrative purposes, and it would be understood that the condition of components and/or raw material monitored and/or measured by the product assurance operations of the system SY3, the inventory levels of components and/or raw material and the availability of machine parts for the machines 16 and elements E controlled and monitored by the production control operations of the system SY3 can affect the operational efficiency and/or downtime of the machines 16 and/or elements E and/or can affect the quality and/or condition of the products produced by and/or the services provided by the machines 16 in multiple ways too numerous to include herein. System SY3 can transmit signals (inputs) to the facility server L3A indicating condition states of the various factors of the operating environment of facility 14A being monitored, measured, and/or controlled by the facility server L3A.

The examples described herein and shown in FIGS. 1 and 2 related to facility 14A are illustrative and non-limiting, and it would be understood that the facilities 14 other than facility 14A included in the enterprise 12 can each include at least one machine 16 configured similar to machine 16A to include a base layer controller L1 and a machine controller L2, however the number and configuration of each of the machines 16 may vary within a facility 14 and from one facility 14 to another facility 14, and each of the machines 16 may include elements E and sensors S arranged in stations ST other than those described for the example of machine 16A to perform operations other than those performed as described for machine 16A.

The example of an enterprise 12 including facilities 14 such as manufacturing plants and/or assembly facilities is not intended to be limiting. An AOS 10 as described herein can be applied to the control and management of any type of enterprise 12 including machines 16 performing coordinated operations, and as such it would be understood that the terms enterprise 12, facility 14, machine 16, element E and sensor S are intended to be defined broadly. By way of non-limiting example, an enterprise 12 can be an amusement park including an AOS 10, where the facilities 14 and machines 16 are defined by different areas of the amusement park and the systems SY can include, for example, a security system for the amusement park and an infrastructure system (water, power, waste disposal, etc.) of the amusement park. In such an example, an amusement ride facility 14A can include machines 16 forming the amusement rides, an admission ticketing facility 14B can include machines 16 for receiving and securing payment for tickets, a dining facility 14C can include machines 16 for providing food service, a parking facility 14C can include machines 16 for receiving parking fees and monitoring and patrolling the parking area, etc. In another non-limiting example, an enterprise 12 including an AOS 10 may be a property development, such as an office building complex, where each facility 14 includes one or more buildings within the complex, and the machines 16 operating in each facility 14 include, for example, elevators, security cameras, heating and ventilation equipment, etc.

In the present illustrative example, the facility server L3A acts as a data collector within the AOS 10 for collecting the inputs received from the systems SY1, SY2 and SY3, and can analyze and use the accumulated data and inputs to identify and respond to operating conditions throughout the facility 14A, including implementing preventive actions to minimize downtime, efficiency losses and/or productivity losses, by controlling and modifying the operations within the facility 16A, which can include outputting commands to the machine controllers L2A through L2E and outputting commands to systems SY2 and SY3, for example, in response to condition states and inputs received from the machine controllers L2A through L2E and systems SY2 and SY3, to modify the operating conditions within the facility 14A, the sequence of operations 39 performed by the various stations ST, the machines 16 and/or stations ST used to perform one or more operations, etc., to improve efficiency, decrease and/or optimize power consumption within the facility, increase productivity, reduce or avoid downtime, etc. in response to the analysis of the data by the facility server L3A.

The AOS 10 is advantaged by accumulating the data and inputs from multiple production (SY1) and non-production (SY2, SY3) systems and multiple machines within a facility 14, analyzing the accumulated data and inputs using a facility server L3 to identify issues which may not be identifiable by the independent machine controllers L2, for example where such issues may result from interactions of multiple inputs which are outside the scope of inputs controlled by any one of the machine controllers L2, and/or which may be identifiable only by combination of inputs from multiple sources (multiple machines 16, a machine 16 and system input from one or more of systems SY2, SY3, etc.), and using the AOS 10 to identify, action responses to, manage and/or prevent issues using the collective resources of the facility 14.

In the present illustrative example, the enterprise server L4 acts as a data collector for the inputs and data received from the facility servers L3A, L3B and L3C. The enterprise server L4 can analyze and use the accumulated data and inputs to control and modify the operations within one or more of the facilities 16A, 16B, 16C, 16D and 16E, including implementing preventive actions to minimize downtime, efficiency losses and/or productivity losses, by controlling and modifying the operations of one or more of the facilities 16A, 16B, 16C, 16D and 16E, in response to an issue or condition identified in one or more of the facilities 16A, 16B, 16C, 16D and 16E, which can include, for example, transferring production between facilities 16 in anticipation of or in response to a downtime event, to increase efficiency based on the operational condition of a machine 16 in one facility 14 as compared to an identical and/or substantially similar machine 16 in another facility 14, to respond to inputs received from the non-production systems SY2 and/or SY3 indicating for example, a facility power supply issue or incoming material issue, etc.

The AOS 10 is advantaged by accumulating the data and inputs from facilities 14, analyzing the accumulated data and inputs using the enterprise server L4 to identify issues which may not be identifiable by the independent facility servers L3, for example where such issues may result from interactions of multiple inputs which are outside the scope of inputs controlled by or received into any one of the facility servers L3, and/or which may be identifiable only by a combination of inputs from multiple facilities L4, and using the AOS 10 to identify, action responses to, manage and/or prevent issues using the collective resources of the enterprise 12. Issues identified by AOS 10, including issues identified by the enterprise server L4 and/or the facility servers L3 can be referred to an issue tracking and resolution system embodied in AOS 10 and described herein, for further issue identification activity, issue investigation, issue containment and corrective action and issue closure upon confirmation of effective issue resolution. The issue tracking and resolution system 200 and method 140 described herein are advantaged by early recognition of an issue through the data analysis, data display, and alert system provided by AOS 10, minimizing the detection time required to detect the issue prior to referring the issue into the issue tracking and resolution system 200. The issue tracking and resolution system 200 and method 140 are further advantaged by structure and operational methodology of the subscriber system 180, issue tracking interface 190, and issue resolution interface 185 of the issue tracking and resolution system 200, which includes a communication structure that expedites each step of the issue resolution method 140 to minimize and/or reduce the time between issue identification and issue resolution, thereby minimizing and/or reducing the detrimental effects which may be caused by the issue, including quality and durability issues, productivity loss, etc.

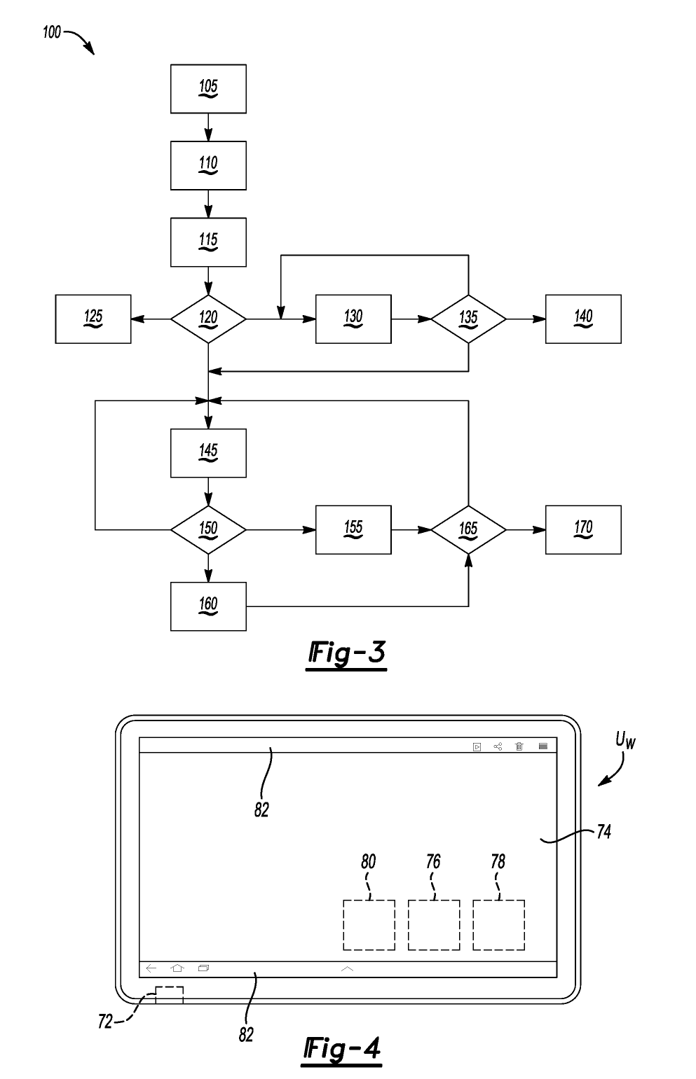

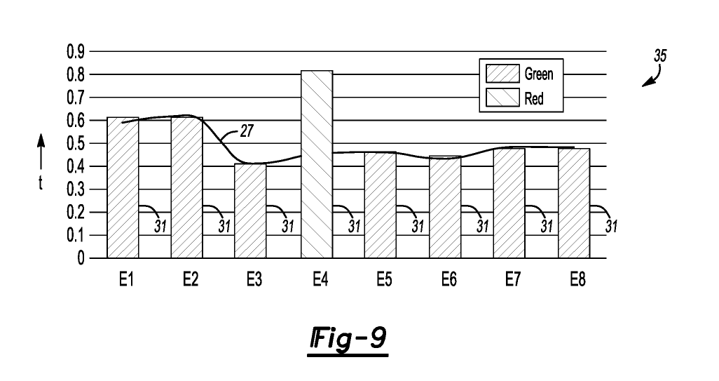

Referring now to FIG. 3, a method for issue tracking and resolution using the issue tracking and resolution system 200 described herein is generally indicated at 100. The issue tracking and resolution (ITR) method 100 may be referred to herein as an ITR method 100, and the issue tracking and resolution (ITR) system 200 may be referred to herein as an ITR system 200. The ITR method 100 is initiated at step 105 with identification of an issue requiring further investigation and/or resolution. The process of identifying an issue for entry into the ITR method 100 and/or ITR system 200 is not limited, such that it would be understood that an issue can be identified using data provided by the AOS 10, information from a source other than AOS 10, in response to a condition state of an element E, station ST, an operation Op, a machine 16, a system SY, etc., in response to monitoring operations of the enterprise 12, receiving an alarm, a fault, a warning, a rejection, an alert, a report, etc., such that it would be understood that the initial identification of an issue for entry of the issue into the ITR method 100 is to be broadly construed. By way of example, an issue could be identified for element E4 shown in FIG. 9, based on an alert sent in response to an alarm set by a machine controller L2 based on a sensor output related to the element E4. As shown in FIG. 9, a non-limiting example of a heartbeat display 35 displays the actual cycle time 31 for each of a group of elements E1 . . . E8, such as elements E1 . . . E8 shown in FIG. 2. In an illustrative example, elements E1 . . . E8 are a group of locking pins which are movable to engage a pallet (not shown) carried by an AGV in the example shown in FIG. 10. The heartbeat display 35 can be displayed on a user device U, where the user can receive an alert to view the heartbeat 35 in response to an alarm set by the machine controller L2 for element E4 and/or a fault set by the facility server L3 for the clamp element E4. In the heartbeat display 35 presented to the user on the user device U, the cycle time 31 displayed for each of the clamp elements E can be color coded to indicate a condition state of the each respective element E. In the example shown in FIG. 13, element E4 may be a different color, such as red, to indicate a fault condition resultant from the cycle time 31 of element E4 exceeding the baseline cycle time heartbeat 27. The remaining cycle time bars 31 may be displayed in a green color, for example, to indicate the remaining elements E1, E2, E3, E5, E6, E7 and E8 in the group are operating within the predetermined tolerance, e.g., are exhibiting cycle times 31 within a tolerance band defined by the baseline heartbeat 27. The user, in response to receiving the alert, can open, e.g., originate an issue based on the alert in the ITR system 200.

At step 110 the issue is entered into the ITR system 200 by an issue originator. The issue originator can be any person involved with, responsible for, and/or related to the issue or to an area, operation, or matter which is or may be impacted by the issue or failure to resolve the issue. In one example, the issue originator must be subscribed to the ITR system 200 as a prerequisite to entering a new issue into the ITR system 200 at step 105. Subscription to the ITR system 200 can be required as a prerequisite to permit the issue originator to access the ITR system 200, for example, to enter (originate) new issues, to view the status of an issue in the ITR system 200, to take an action on an issue, to respond to an issue notification, to subscribe to issue notifications for one or more directory items, to transfer an issue, to received and/or decline transfer of an issue, to view ITR system reports, to view issue related materials and information associated with an issue it the ITR system, to change an issue status, for example, from in-process to resolved, to park an issue, etc. In another example, the issue originator need not be subscribed to the ITR system 200 as a prerequisite to entering a new issue into the ITR system 200. In this case, the issue originator's access to issue tracking and resolution information may be limited in scope or access may not be permitted. In one example, an issue originator who is not subscribed to the ITR system 200 may enter the issue into the ITR system 200 and request the ITR system 200 to provide a status notification when the issue which has been entered by the issue originator is, by way of example, updated, resolved, parked, etc. The status notification may be provided by the ITR system 200 to the non-subscriber originator, for example, via an email notification, text or SMS message, voice mail message, etc, which does not require the issue originator to subscribe to the ITR system 200.

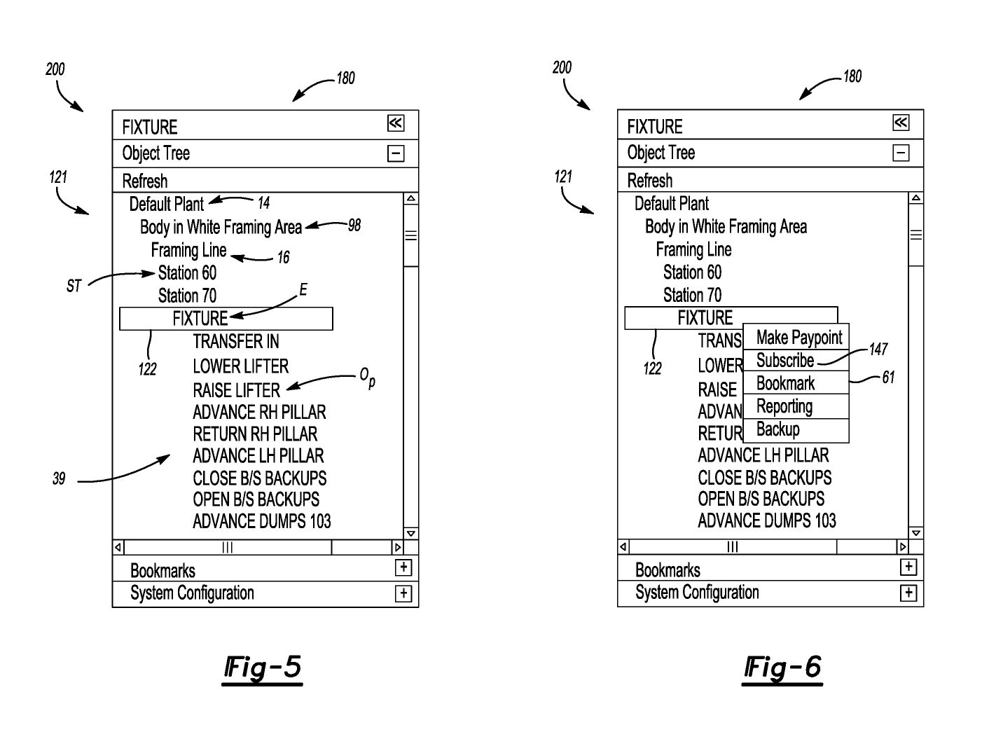

Referring to FIGS. 5 and 6, shown is an illustrative example of a portion of a subscriber interface 180 for use in subscribing to the ITR system 200. The ITR system 200 can include, by way of non-limiting example, a server, such the enterprise server L4, which can be embodied as one or more computer devices having a processor 94 and a memory 92, some of which is computer-readable tangible, non-transitory memory arranged on a printed circuit board or otherwise available to the processor 94. Instructions embodying the methods described herein may be programmed into memory 92 and executed as needed via the processor 94 to provide functionality of the ITR system 200 as described herein. The memory 92 may include, by way of example, sufficient read only memory (ROM), optical memory, flash or other solid state memory, and the like. Transitory memory such as random access memory (RAM) and electrically-erasable programmable read-only memory (EEPROM) may also be included, along with other required circuitry (not shown), including but not limited to a high-speed clock, current/voltage/temperature/speed/position sensing circuitry, analog-to-digital (A/D) circuitry, digital-to-analog (D/A) circuitry, a digital signal processor, and any necessary input/output (I/O) devices and other signal conditioning and/or buffer circuitry. The server included in the ITR system 200, for example, the enterprise server L4, can include a communications interface 96 for communication with other controllers and/or servers in the enterprise 12, including for example, for communication with each of a third layer server L3, a second layer controller L2 and a first layer controller L1 of the enterprise 12, and for communication with one or more user devices U, for example via the network 80. The ITR system 200 can include sufficient memory for operating the ITR system 200, storing issue related information and data, etc., and can be in communication with and/or utilize shared or distributed memory within the enterprise 12, including for example, the data memory storage 90. In one example, the ITR system 200 is included in the AOS 10 and the enterprise 12. In one example, the ITR system 200 can be a distributed system residing on a plurality of servers in communication with each other, such as one or more of the enterprise server L4 and the facility servers L3.

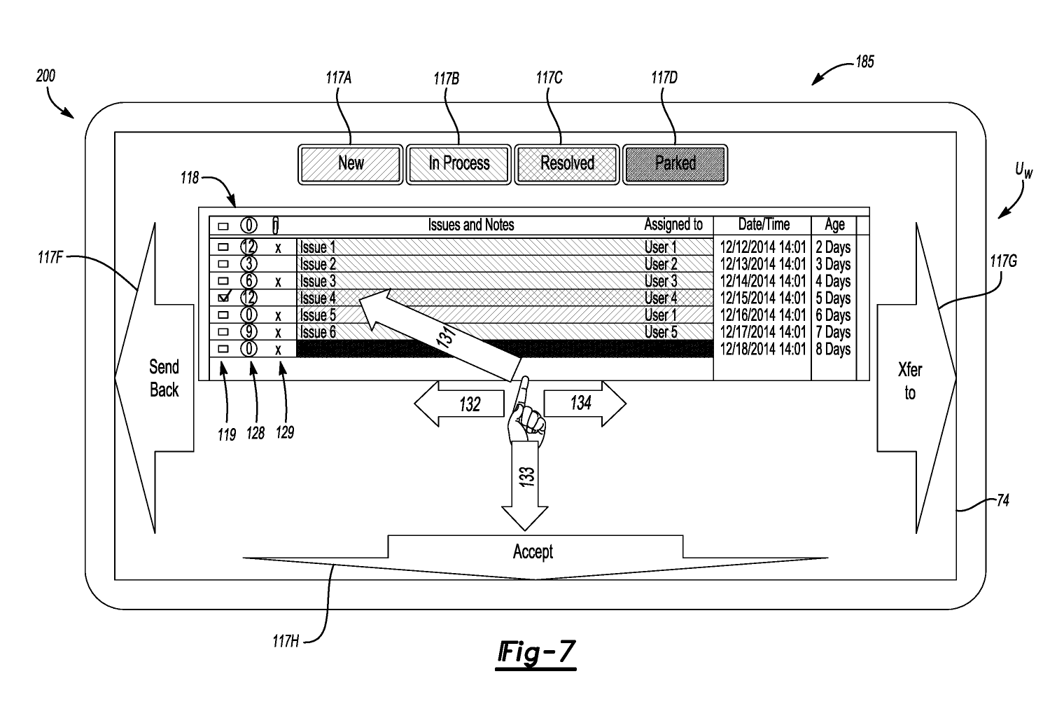

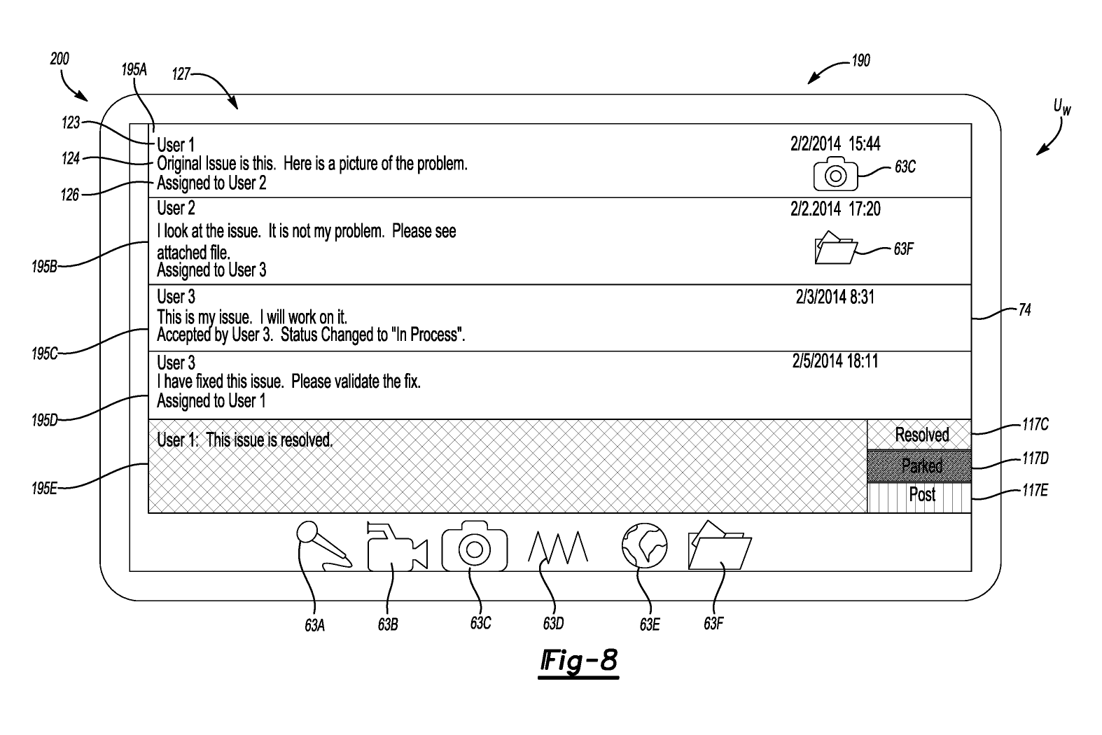

The ITR system 200 includes one or more interfaces for accessing the ITR system 200. In a non-limiting example, the ITR system 200 includes a subscription interface 180 which is shown in part in FIGS. 5 and 6, an issue tracking interface 180 for tracking issues entered into the ITR system 200 which is shown in part in FIG. 7, and an issue resolution interface 185 for access to issue resolution logs associated with each of the issues entered into the ITR system 200, which is shown in part in FIG. 8, which are accessible via a user device U in communication with the ITR system 200, for example, via the network 80. The examples shown in here are illustrative and non-limiting, and it would be understood that each of these interfaces 180, 185, 190 can include multiple other interface screens for accessing and interacting with the respective interface. For example, at least one of the issue tracking interface 180 and the issue resolution interface 185 would include additional interface screen for inputting the issue to the ITR system 200. For example, each of the issue tracking interface 180 and issue resolution interface 185 would include additional interface screens for generating reports, viewing issue details including information associated with an issue, viewing issue tracking and resolution metrics, etc. Referring again to FIGS. 5 and 6, the subscription process can begin with a user, via a user device U, accessing the subscription interface 180 to subscribe to the ITR system 200. The subscriber, in one example, can be required to provide credentials and/or authorize him/herself to the ITR system 200 as an authorized subscriber. The ITR system 200 can include an authentication or controlled access mechanism, such that the subscriber may be issued credentials and/or a subscriber identification and password for use in accessing the ITR system 200 once subscribed. During the subscription process, by way of illustrative example, the subscriber can select preferences such as preferred notification methods to be used when communicating with the subscriber, e.g., such as text, phone, email, social network, etc.

During the subscription process, the scope of the subscriber's subscription, e.g., the scope of issues the subscriber will have access to and/or receive notification of in the ITR system 200, can be established by the subscriber and/or an administrator of the ITR system 200. For example, an administrator can establish and/or restrict the scope of the subscriber's subscription based on one or more of the subscriber's employment, membership or other relationship status with the enterprise 12 operating the ITR system 200. The administrator can establish and/or restrict the scope of the subscriber's subscription based on any combination of factors such as, by way of example, the subscriber's job position, job function, technical qualifications, geographic location, etc. The administrator can establish and/or restrict the scope of the subscriber's subscription based on one or more other factors such a time duration of the subscription, for example, if the subscriber is a contract employee, the subscription duration can be limited to the term of the subscribers employment contract. The administrator can establish and/or restrict the scope of the subscriber's subscription based on need to know criteria, where in an illustrative example the subscriber can be given full access to view issue files, enter comments into tracking and resolution databases and/or upload information into the ITR system 200, and/or act on issue files including dispositioning an issue file to a resolved or parked status, or can be given minimal access such as view only access, or can be subscribed at an access level therebetween, where the scope of access can also be varied based on the subject matter of the issue.

Referring again to FIGS. 5 and 6, the subscriber can subscribe to all issues, or can establish and/or restrict the scope of the subscriber's subscription, for example, to issue subject matter for which the subscriber may be responsible, for example, based on the subscriber's relationship with the enterprise as an employee, supplier, etc., and/or may be determined by the subscriber based on the subscriber's qualifications and/or interests. During the subscription process, a directory structure 121 defined by the structure of the enterprise 12 and/or a portion thereof, for example, defined by a facility 14 in which the subscriber is employed or located, can be presented to the subscriber for selection by the subscriber of the directory items 122 for which the subscriber is subscribing. By subscribing to a directory item 122, the subscriber will receive issue notifications related to the directory item 122, which can include, for example, an initial notification that an issue related to the subscribed area has been originated in the ITR system 200, a notification of a request to transfer a responsibility or action related to the issue to the subscriber, a notification requesting the subscriber to join an issue team formed to resolve the issue, a status update notification, etc. In an illustrative example, the directory structure 121 is defined as an object structure including, as shown in FIGS. 5 and 6, a listing of one or more elements E, stations ST, machines 16, zones 98, operations Op, which may be displayed in a sequence of operations, which are included and/or performed within the enterprise 12 and/or a facility 14 of the enterprise 12. The example of the directory structure 121 shown in FIGS. 5 and 6 is non-limiting, and the directory structure 121 can include, for example, issue groupings such as purchased material, tooling, safety, HVAC. In one example, the subscription may be scoped by keyword, such as clamp, pneumatic, dunnage, stamping, etc. By way of example, a subscriber can elect to subscribe to as few as one directory item 122. In the illustrative example shown, the subscriber can subscribe to a directory item 122, for example, by selecting the directory item 122 from the directory structure 121, for example, by selecting a directory item 122 listed as “FIXTURE” in Station 70, as shown in FIG. 5, which activates a drop down menu displayed in a pop-up screen 61 for the subscriber to select “Subscribe” to complete the subscription process for the selected directory item 122. In one example, the subscriber can execute the subscription process using a user device U including a touch screen 74, where the subscriber can select directory items 122 for subscription using touch input to the touch screen 74. In one example, the subscriber can update and/or revise the directory items 122 the subscriber is subscribed to at any time, by accessing the subscriber interface 180 of the ITR 200.

Referring again to the ITR method 100, at step 110 the issue originator inputs the issue identified at step 105 into the ITR system 200, where inputting the issue can include one or more of inputting issue identifying information include the identity of the issue originator, information supporting the initial identification of the issue such as fault reports, alarm data, warning content, problem reports or other issue identifying information, selecting directory item(s) related to the issue and/or keywords characterizing the issue, selecting one or more categories to which the issue belongs and/or is related, inputting information related to the issue which can be uploaded and/or inputted into the ITR system 200 as one or more of voice data, video data, camera data, signal data, location data, and/or other data including reports, documentation, etc. related to the issue, using, for example, upload elements 63A-63F corresponding to the different data formats (voice, video, camera, etc.) to be updates, as shown on the issue resolution interface 185 in FIG. 8. The issue originator at step 110 and using the issue tracking interface 180 shown in FIG. 7, uses the status indicator inputs 117A-117D to assign the issue as one of a new issue using input 117A, an in-process issue using input 117B, a resolved issue using input 117C, and a parked issue using input 117D. In the present example, the issue originator would select status input 117A to indicate the issue is a new issue. Still continuing at step 110, the issue originator may assign the issue to at least one other subscriber, where assigning the issue to the other subscriber causes the ITR system 200 to send a notification to the other subscriber that a new issue has been assigned to him/her. By way of example, the issue originator can optionally send a notification to a non-subscriber that a new issue has been assigned to him/her, requesting the non-subscriber to subscribe to the ITR system 200 and review the assignment request and new issue.

After the issue input step 110 is completed, the method proceeds to step 115, where a new issue notification is sent by the ITR system 200 to select subscribers based on, for example, a match between the subscriber's subscription preferences and the categories, keywords, and directory items selected by the issue originator for association with the new issue, and the subscription. The subscription process and the subscriber notification process described for step 110 expedites notification of the new issue to those who have a need to know and/or a responsibility or desire to participate in the issue resolution process, and expedites the formation of an issue resolution team to resolve the new issue, by early notification of the issue to subscribers with responsibility for the issue, for example, due to the subscriber's job position, and/or by assignment of the issue to subscribers as a request to the assigned subscriber to participate in the issue resolution, e.g., as a member of the issue resolution team. The communication methods used to provide immediate notification at step 115 to subscriber, including those subscribers who have been assigned to the issue by the issue originator, including for example notification methods such as e-mail, SMS messaging, instant messaging (IM), social network messaging (Twitter®, Facebook®, etc.), and the immediate electronic access to issue identifying information which has been uploaded by the issue originator to the ITR system 200 expedites the initiation of the issue resolution process by providing immediate access to subscriber/issue team members to educate themselves on the nature and substance of the new issue.

At step 120 of the ITR method 100, a subscriber receiving a notification of the issue can respond to the notification by accessing the issue tracking interface 180 shown in FIG. 7, to review the issue and related information in the ITR system 200, and by taking one of three actions as shown in FIG. 3. The issue tracking interface 180 can be accessed by the notified subscriber using a user device U including a touch interface such as a touch screen 74, and such that the user-subscriber can interact with the issue tracking interface 180 and/or the issue resolution interface 185 by applying a touch input to the touch screen 74. An issue listing 118 can be displayed to the subscriber, where in one example, the issue listing 118 includes the issues for which the subscriber has received notification, been assigned or otherwise took responsibility, such that the subscriber can easily view and access only those issues which are associated with that subscriber. Each issue in the issue listing 118 can be differentiated by a color or pattern to show the status of the issue, where a dispositioning button 117 can be differentiated by the same color or pattern as the issue status. For example, as shown in FIG. 7, the dispositioning button 117D for dispositioning an issue to a “parked” status is shaded. Issue 7 in the issue listing 118 is also shaded, indicating Issue 7 is in a parked status. Likewise, “Resolved” dispositioning button 117C and Issue 4 are both double-cross hatched (as shown in the figure), indicating Issue 4 has been dispositioned to a “resolved” status. In another example, a subscriber can edit and/or limit the issues shown in the issue listing 118 using the dispositioning buttons 117A . . . 11D. For example, by pressing on the “New” button 117A, only issues which have a “New” status such as Issue 5 the issue listing 118 shown in FIG. 7, will be displayed on the issue listing 118.

At step 120 the subscriber can select the issue for which the subscriber has received a notification, from an issue listing 118 displayed on the issue tracking interface 180, and apply a touch input such as a fingertip pressure to the line displaying the selected issue as indicated by arrow 131 in FIG. 7, to actuate the issue tracking interface 180 to display additional information about the selected issue, including, for example, a menu or listing of issue identifying information which has been uploaded by the issue originator. File information associated with an issue in the ITR system 200 can be identified with a corresponding icon, as shown by the photo icon 63C shown in a log entry 195A made to an issue resolution log 127 displayed by the issue resolution interface 185 in FIG. 8. Applying a touch input to the photo icon 63C can activate the issue resolution interface 185 to display the photo to the subscriber. The notified subscriber can review the issue identifying information and any additional information related to the issue, such as log entries 195A . . . 195E shown in the issue resolution log 127, can act on the issue at step 120. In a first option, a notified subscriber who received a notification assigning the issue to the notified subscriber can respond by sending the issue back to the issue originator, for example, by selecting the issue, such as new Issue 5, and using a sliding touch input as indicated by arrow 132 to return the issue to the issue originator, which also removes the returned issue, in this example Issue 5, from the issue listing 118. The notified subscriber can return the issue to the issue originator by selecting the new Issue 5 by a touch pressure, then applying a touch input to the “Send Back” button 117F. The notified subscriber when sending back the issue, can make a log entry to the issue resolution log 127, for example, including inputting into a comment field 124 a reason for sending the issue back. As shown in FIG. 8, each log entry 195A . . . 195E includes a subscriber identifier field 123, a comment field 124, and an action field 126. After a log entry is entered, as shown for log entry 195E in FIG. 8, the subscriber selects one of the buttons 117C, 117D, 117E to respectively indicate the issue is resolved by selecting button 117C), to park the issue by selecting button 117D or to post the log entry by selecting button 117E. After sending the issue back, the method 100 proceeds to step 125 and the issue originator received notification that the notified subscriber has returned the issue.

The notified subscriber at step 120 can accept the issue by selecting the new Issue 5 by a touch input to the line displaying Issue 5 in the issue listing 118, and inputting a sliding motion as shown by arrow 133 in FIG. 7 toward the “Accept” button 117H. Alternately, the notified subscriber can input a touch input to the “Accept” button 117H to accept the issue, and can make an entry to the issue log, as shown by log entry 195C on FIG. 8. After accepting the issue, the method 100 proceeds to step 145 where actions which are taken to investigate and/or resolve the issue are posted to the issue log 127, as shown by log entry 195D on FIG. 8.

The notified subscriber at step 120 can transfer the issue to another subscriber by selecting the new Issue 5 and inputting a sliding motion as shown by arrow 134 in FIG. 7 toward the “Xfer (transfer) to” button 117G. Alternatively, the notified subscriber can input a touch input to the “Xfer to” button 117G to transfer the issue. The issue tracking interface 180 can display a prompt, for example, in a pop-up window or otherwise, requesting information to identify the subscriber to whom the notified subscriber is transferring the issue. As shown in the example, log entry 195A is made by a subscriber identified in field 123 as User 2 who has inputted a comment into comment field 124 indicating this is not his issue and attaching a document file indicated by icon 63F in support. The action field 126 indicates that User 2 has assigned, e.g., has transferred, the issue to User 3. In an illustrative example, the document attached to log entry 195B can be a document such as a stoppage time display 106B for showing cumulative stoppage times in a current production shift for each of four zones (Zone 1 through Zone 4) in a plant assembly area. In an illustrative example, the stoppage time display 106B displays stoppage data sensed for automatic guided vehicles (AGVs) (not shown) used to move products from one station ST to the next station ST in an assembly area within each zone, where it is desirable that each AGV moves continuously without stoppage through every station ST in the zone. A zone can be, for example, a zone such as zones 98A, 98B, 98C shown in FIG. 11, where each zone 98A, 98B, 98C is configured similarly such that comparison of the stoppage time in one zone 98 to another zone 98 facilitates identification and prioritization of top causal factors of stoppage time for issue resolution and corrective action and/or replication of best practices across the zones. Referring to FIG. 10, AOS 10 collects stoppage time data from each of the zones 1 through 4, and displays the data to the stoppage time display 106B, where the data can be displayed in real time at the actual time during the production shift when the data display 106B is generated. The ability to observe the stoppage time data in real time expedites issue identifies, as there is no delay for data compilation, report compilation, etc. Shown for each of the zones 1 through 4 is a vertical bar 107 representing cumulative starved time during the current production shift. Starved time includes stoppage time of AGVs in the zone which is caused by a starved state, for example, due to a parts shortage. For each zone, vertical bars 108 representing other stoppage time of AGVs in the zone is shown for the current shift. Other stoppage time includes stoppage time caused by causes other than blocked or starved, such as a quality system (QS) stop, a tool stop, a zone safe stop, and/or a miscellaneous stop. In one example, each stoppage can be grouped as micro (less than 30 seconds) minor (between 30 seconds to 2 minutes) and/or major (over 2 minutes) stops. For each zone, a vertical bar 109 representing cumulative blocked time during the shift is shown. Blocked time includes stoppage time of AGVs in the zone which is caused by a blocked state, for example, due to stoppage of an AGV in a downstream station. Each of the vertical stoppage time bars 107, 108, 109 in the present example is differentiated by color (shown in the figure as shading indicating colors by name for clarity of illustration) to display each of the bars 107, 108, 109 in one of the modes 143. In the present example the “yellow” mode 143 indicates starved time, the “gold” mode 143 indicates other stoppage time, and the “blue” mode 143 indicates blocked time. In the lower portion (as shown on the page) of FIG. 10, a top causal factor display 111 is shown, also referred to as a hotspots display 111 showing the top causal factors 149 of stoppage time. In the example shown, the top causal factor 149 of stoppage time is QS (quality system) stop time occurring in station 350 of sub-zone 3A of zone 3, and the horizontal bar (as shown in the figure) showing total stoppage time 149 for this causal factor, is displayed in the “gold” mode 143 indicating the top causal factor 149 is other stoppage time, specifically QS stop time, in station 350. The stoppage time display 106B can be generated from data collected by AOS 10, for example, by a facility server L3, such that the stoppage time display 106B can be viewed in real time, e.g., immediate with viewing the operations of the AGVs being recorded for display in the stoppage time display 106B, and is by providing in immediate time, e.g., in real time, an visually efficient and visually effective and succinct consolidation of data regarding, in the present example, the condition state of multiple zones within a production facility, such that a user/view of the data display can rapidly assess the condition states, identify issues, initiate an issue tracking and resolution file, determine priorities for corrective actions and/or countermeasures for issues including identified quality issues and productivity or efficiency losses, and/or identify best practices for replication across the zones. As related to the present example, the document shown in FIG. 10 may be attached to the log entry 195B to provide additional information to assist in resolving the issue. In the illustrative example, element E4 in FIG. 9 is described as a locking pin which is movable to engage a pallet (not shown) carried by an AGV, such as an AGV shown as stopped due to a “tool stop.” User 2 can be including the stoppage time display 106B of FIG. 10 in the issue resolution log 127, as indicated at log entry 195B, to indicate the issue may be related to the stoppage time being incurred in Zone 3C due to faulting of element E4. The illustrative example shows the advantage of expediting issue identifying information using the communication and notification capabilities of the ITR system 200, to expedite compiling information from independent areas and/or sources which can be useful in diagnosing or resolving the issue.

Referring again to FIG. 3, upon transferring the issue to another subscriber, the method 100 continues from step 120 to step 130. At step 130 the issue is transferred from the notified subscriber to the transferred subscriber and notification is sent to the transferred subscriber that the issue has been transferred, e.g., assigned to the transferred subscriber from the notified subscriber. At step 135 the transferred subscriber reviews the issue, and as described for the notified subscriber related to step 120, the transferred subscriber at step 135 either sends the issue back to the notified subscriber and the method 100 proceeds to step 140, where the notified subscriber is notified the issue has been returned, or the transferred subscriber transfers the issue to a third subscriber and the method 100 proceeds to step 130 to notify the third subscriber that the issue has been transferred from the transferred subscriber to the third subscriber, or the transferred subscriber accepts the transferred issue, for example, as noted by User 3 in log entry 195D shown in FIG. 8, and the method 100 proceeds to step 145. At step 145, actions are taken by one or more of the subscribers that have accepted the issue and logged to the issue resolution log 127, until sufficient actions are taken to resolve the issue. At step 150, in response to an action taken at step 145, the action and/or additional information may be posted to the issue resolution log and the method 100 returns to step 145 for additional resolution activity. At step 150, the issue may be parked for a predetermined period of time, for example, to observe an implemented fix over the predetermined time to determine the effectiveness of the fix in resolving the issue, and/or to monitor an operation Op, element E and/or machine 16 or the like for a recurrence of the issue. In this case the method proceeds to step 160 and the issue is parked for the predetermined time, and if there is no recurrence of the issue, the method proceeds to step 165 for confirmation of resolution. The status of the issue is changed to parked using the issuing tracking interface 180 at step 160. At step 150, for example as shown by log entry 195D in FIG. 8, a request for validation of a resolution or issue fix may be sent to the issue originator and/or a subscriber with responsibility to verify the fix has resolved the issue and the method proceeds to step 155. At step 155 the issue is reviewed for resolution. At step 165 a determination is made whether the issue fix has been effective, e.g., whether the issue has been resolved. If the issue has been resolved, the method 100 proceeds to step 170 and the issue is closed. If the issue has not been resolved, the method 100 returns to step 145 for additional issue resolution actions.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An issue tracking and resolution method comprising:
identifying an issue;
wherein the issue is identified by an issue originator;
associating the issue with at least one directory item of a directory;
notifying a first subscriber of the issue;
wherein the first subscriber is subscribed to the at least one directory item prior to identifying the issue;
wherein the issue can be selectively dispositioned by the first subscriber by each of:
the first subscriber accepting the issue;
the first subscriber transferring the issue to a second subscriber; and
the first subscriber returning the issue to the issue originator;
the method further comprising the first subscriber selectively dispositioning the issue by one of:
accepting the issue;
transferring the issue to a second subscriber; and
returning the issue to the issue originator.

2. (canceled)

3. The method of claim 1, wherein the at least one directory item is one of a machine and an operation performed by a machine.

4. The method of claim 1, further comprising:
inputting the issue into an issue tracking and resolution (ITR) system via a network;
inputting issue identification information into the ITR system via the network;
associating the issue and the issue identification information in the ITR system; and
associating the issue and the at least one directory item in the network.

5. The method of claim 4, wherein:
the first subscriber is notified of the issue via the network; and
the first subscriber dispositions the issue via the network.

6. An issue tracking and resolution method comprising:
receiving an issue to an issue tracking and resolution (ITR) system via a network in communication with the ITR system;
the ITR system having a directory including a plurality of directory items; and
associating the issue with a first directory item of the plurality of directory items;
wherein the plurality of directory items includes at least one machine and at least one operation performed by the machine;
subscribing a first subscriber to the ITR system via the network; and
associating the first subscriber with at least one directory items of the plurality of directory items;
sending an issue notification to the first subscriber when the first directory item matches the at least one directory item associated with the first subscriber;
wherein the issue can be selectively dispositioned by the first subscriber via the network by each of:
the first subscriber accepting the issue;
the first subscriber transferring the issue to a second subscriber; and
the first subscriber returning the issue to the issue originator;
the method further comprising the first subscriber selectively dispositioning the issue by one of:
accepting the issue via the network;
transferring the issue to a second subscriber via the network; and
returning the issue to the issue originator via the network.

7. (canceled)

8. The method of claim 7, further comprising:
comparing the first directory item and the at least one directory item associated with the first subscriber using the ITR system.

9. The method of claim 8, wherein:
the issue notification is received by the first subscriber via the network.

10. The method of claim 9, wherein the ITR system includes an issue resolution log, the method further comprising:
the first subscriber posting a log entry to the issue resolution log reporting the disposition performed by the first subscriber.

11. An issue tracking and resolution system comprising:
a server in communication with a network;
the server including an issue tracking and resolution (ITR) system defining a first interface for receiving an issue to the ITR system via the network;
the server including a directory including a plurality of directory items; and
wherein receiving the issue includes associating the issue with at least one directory item; and
wherein the first interface is configured for a subscriber to the ITR system to selectively disposition the issue by each of:
returning the issue notification to an issue originator;
transferring the issue notification to a second subscriber of the ITR system; and
accepting the issue notification.

12. The system of claim 11, further comprising:
the ITR system defining a second interface for subscribing the subscriber to the ITR system via the network;
wherein the second interface is configured to display the directory including the plurality of directory items such that the subscriber can select at least one directory item as a subscribed directory item.

13. The system of claim 12, further comprising:
the ITR system configured to:
compare the at least one directory item associated with the issue with the subscribed directory item; and
send an issue notification to the subscriber when the at least one directory item associated with the issue and the subscribed directory item match.

14. The system of claim 13, wherein the issue notification is one of a text message, an SMS message, and an email message.

15. The system of claim 13, wherein the first interface is accessible by the subscriber via a user device in communication with the network;
wherein the first interface is configured for the subscriber to disposition the issue by one of:
returning the issue notification to the issue originator;
transferring the issue notification to the second subscriber of the ITR system; and
accepting the issue notification.

16. The system of claim 11, wherein the plurality of directory items includes at least one machine and at least one operation performed by the machine.
